(19) United States
(12) Patent Application Publication
(10) Pub. No.: US 2022/0305930 A1
(43) Pub. Date: Sep. 29, 2022

(54) VEHICLE CHARGING SYSTEM AND METHOD OF CONTROLLING VEHICLE CHARGING SYSTEM

(71) Applicant: TOYOTA JIDOSHA KABUSHIKI KAISHA, Aichi-ken (JP)

(72) Inventor: Shigeki KINOMURA, Toyota-shi (JP)

(21) Appl. No.: 17/699,176

(22) Filed: Mar. 21, 2022

(30) Foreign Application Priority Data
Mar. 26, 2021 (JP) 2021-053167

(51) Int. Cl. B60L 53/31; B60L 53/30; B60L 53/67

(52) U.S. Cl. CPC B60L 53/31; B60L 53/305; B60L 53/67

(57) ABSTRACT

A charging system for a vehicle includes at least one charging stand. The at least one charging stand includes a movable portion, an elevation unit, and a notification device. The movable portion includes an inlet for transmitting electric power to the vehicle. The elevation unit lifts and lowers the movable portion between an exposed state in which the movable portion is exposed from ground and a stored state in which the movable portion is stored underground. The notification device includes at least one of a light emitter that emits light during lifting and lowering of the movable portion, and a speaker that outputs sound during lifting and lowering of the movable portion, to notify a surrounding of the lifting/lowering of the movable portion.

This nonprovisional application is based on Japanese Patent Application No. 2021-053167 filed on Mar. 26, 2021 with the Japan Patent Office, the entire contents of which are hereby incorporated by reference.

### BACKGROUND

### Field

The present disclosure relates to a vehicle charging system, and a method of controlling the vehicle charging system.

### Description of the Background Art

Vehicles that can be charged with electric power supplied from a source external to the vehicles, i.e., charged by so-called plug-in charging, are becoming widespread. Charging facilities for plug-in charging are generally installed in parking lots or the like and occupy a certain extent of space for installation. A technique has therefore been proposed for providing a movable charging system that can be stored underground. For example, a charging pole disclosed in Japanese Patent No. 5475407 can be placed upright on the ground and can also be stored underground.

### SUMMARY

A movable charging system may be installed on a walkway or the like located near a parking space. Because its movable portion is stored underground when not in use, it is not easy for pedestrians to notice the presence of the movable portion. Passage of pedestrians could thus be hindered by lifting/lowering of the movable portion.

The present disclosure is given to solve the above-identified problem, and an object of the present disclosure is to reduce the risk of hindering passage of pedestrians due to lifting/lowering of the movable portion of the movable charging system.

(1) A charging system for a vehicle according to an aspect of the present disclosure includes at least one charging stand. The at least one charging stand each includes a movable portion, an elevation device, a notification device, and a control device. The movable portion includes an electric power transmitter that transmits electric power to the vehicle. The elevation device lifts and lowers the movable portion between an exposed state in which the movable portion is exposed from ground and a stored state in which the movable portion is stored underground. The notification device includes at least one of a light emitter that emits light during lifting and lowering of the movable portion and a speaker that outputs sound during lifting and lowering of the movable portion, to notify a surrounding of at least one of lifting and lowering of the movable portion. The control device controls the elevation device and the notification device.

With the above features of (1), the light emitter and/or the speaker notifies the surrounding of the lifting/lowering of the movable portion. Thus, the risk of hindering passage of pedestrians due to lifting/lowering of the movable portion can be reduced.

(2) The notification device includes the light emitter. The control device reduces an amount of light emission from the light emitter during a predetermined period of time in nighttime, relative to an amount of light emission from the light emitter during a period of time other than the predetermined period of time.

(3) The notification device includes the speaker. The control device reduces a volume of sound from the speaker during a predetermined period of time in nighttime, relative to a volume of sound from the speaker during a period of time other than the predetermined period of time.

With the above features of (2) and (3), the amount of light emission from the light emitter and/or the volume of sound from the speaker is reduced during nighttime, and accordingly annoyance that could be caused to neighborhood residents or pedestrians can be suppressed.

(4) The at least one charging stand is a plurality of charging stands. The notification device of each of the plurality of charging stands includes the light emitter and the speaker. When the movable portion of each of two or more charging stands among the plurality of charging stands is lifted and lowered, the control device causes the speaker to output sound that is included in a part of the two or more charging stands, and causes the light emitter to emit light and the speaker to output no sound that are included in remaining at least one charging stand among the two or more charging stands.

If the movable portions of two or more charging stands are lifted/lowered and sound is output from respective speakers of all these charging stands, neighborhood residents or pedestrians could be annoyed. With the above features of (4), sound is output from only a part of the two or more charging stands, and accordingly, such annoyance can be reduced.

(5) The at least one charging stand is a plurality of charging stands. The notification device of each of the plurality of charging stands includes the speaker. When the movable portion of each of two or more charging stands among the plurality of charging stands is lifted and lowered, the control device causes respective sounds that are output from the speakers of the two or more charging stands to be synchronized with each other.

With the above features of (5), respective sounds from the speakers are synchronized with each other, and therefore, annoyance that could be given to neighborhood residents or pedestrians can be reduced relative to the one when the sounds are not synchronized with each other.

(6) A method of controlling a charging system for a vehicle according to another aspect of the present disclosure includes first and second steps. The first step is the step of lifting and lowering a movable portion between a state in which the movable portion is exposed from ground and a state in which the movable portion is stored underground, the movable portion including an electric power transmitter that transmits electric power to the vehicle. The second step is the step of notifying a surrounding of at least one of lifting and lowering of the movable portion by means of light or sound.

With the above method of (6), the risk of hindering passage of pedestrians due to lifting/lowering of the movable portion can be reduced, as with the above features of (1).

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an example layout of a vehicle charging system according to Embodiment 1.

FIG. 2 shows an example configuration of a charging stand that is stored underground and a vehicle.

FIG. 3 shows an example configuration of the charging stand that is exposed from the ground and the vehicle.

FIG. 4 is a flowchart showing an example process procedure for lifting/lowering control for the charging stand according to Embodiment 1.

FIG. 5 is a flowchart showing an example process relating to condition setting for lifting/lowering control for a charging stand according to a modification of Embodiment 1.

FIG. 6 is a flowchart showing an example process relating to condition setting for lifting/lowering control for a charging stand according to Embodiment 2.

FIG. 7 is a flowchart showing an example process relating to condition setting for lifting/lowering control for a charging stand according to Embodiment 3.

### DESCRIPTION OF THE PREFERRED EMBODIMENTS

Embodiments of the present disclosure are described hereinafter with reference to the drawings. In the drawings, the same or corresponding parts are denoted by the same reference characters and a description thereof is not herein repeated.

### Embodiment 1

<Configuration of Charging System>

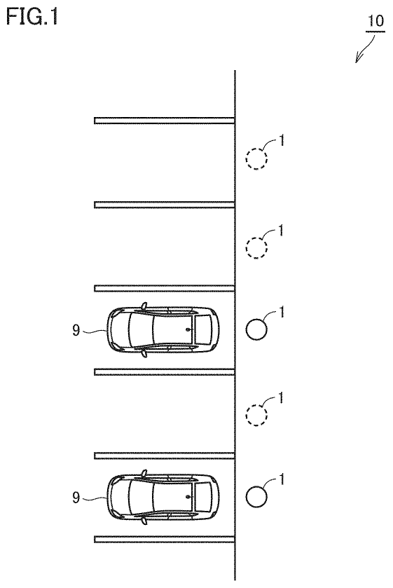

FIG. 1 shows an example layout of a vehicle charging system according to Embodiment 1. In FIG. 1, vehicles 9 parked in two respective parking spaces among a plurality of parking spaces provided in a parking lot are illustrated.

In the present embodiment, charging system 10 includes a plurality of charging stands 1. A plurality of charging stands 1 are each installed in a space (walkway for example) adjacent to a parking space. The number of installed charging stands 1, however, is not particularly limited. The number of installed charging stands 1 may also be only one.

Charging system 10 is configured to enable each charging stand 1 to be lowered and lifted between a “stored state” of being stored underground and an “exposed state” of being exposed from the ground (movable up-and-down). In FIG. 1, charging stand 1 exposed from the ground is indicated by a solid line and charging stand 1 stored underground is indicated by a dashed line.

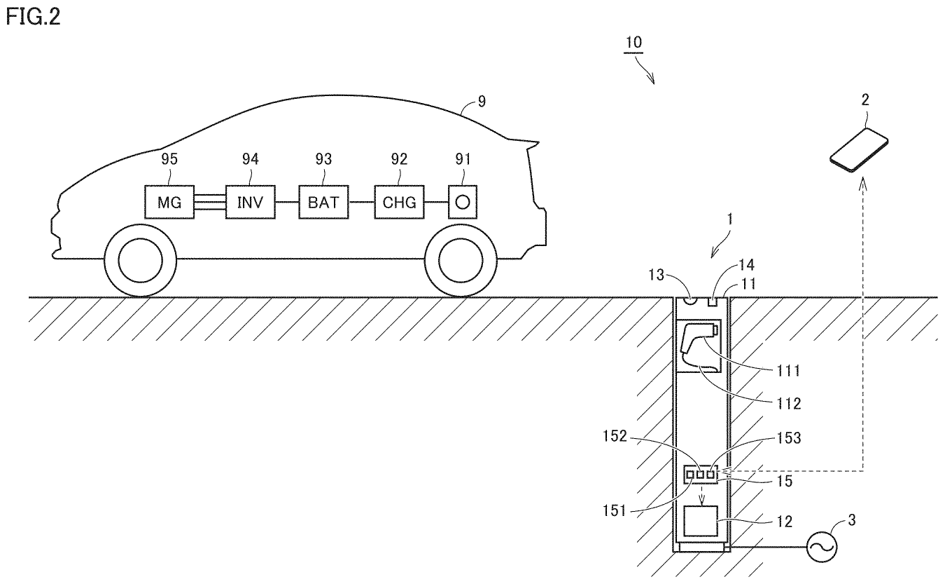

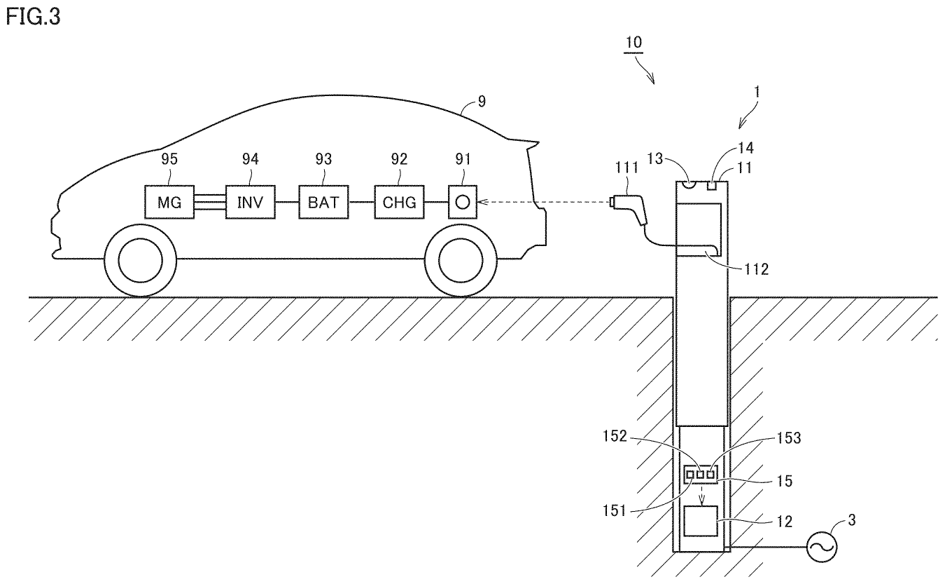

FIG. 2 shows an example configuration of charging stand 1 that is stored underground and vehicle 9. FIG. 3 shows an example configuration of charging stand 1 that is exposed from the ground and vehicle 9. The stored state as shown in FIG. 2 refers to a state of charging stand 1 having been lowered until the upper end of charging stand 1 is located substantially at the same height as the ground. The exposed state as shown in FIG. 3 refers to a state of charging stand 1 having been lifted until the upper end of charging stand 1 is located at a predetermined height above the ground.

Charging stand 1 has a cylindrical housing, for example. Charging stand 1 is installed on the bottom of a recess formed in the ground. The recess is formed to leave a predetermined gap to the outer peripheral surface of the housing of charging stand 1. The depth of the recess is substantially equal to the vertical length of charging stand 1 in the stored state.

Charging stand 1 is configured to be capable of plug-in charging for vehicle 9. Charging stand 1 is configured to communicate with a mobile terminal (smart phone for example) 2 of a user. Charging stand 1 is controlled in accordance with operation performed by a user on mobile terminal 2. Charging stand 1 may be configured to communicate with vehicle 9. In this case, charging stand 1 is controlled in accordance with operation performed on an operation panel or the like (not shown) of vehicle 9. Charging stand 1 includes a movable portion 11, an elevation unit 12, a light emitter 13, a speaker 14, and a controller 15.

Movable portion 11 is configured to be lifted and lowered by elevation unit 12. While the direction in which movable portion 11 is lifted and lowered is the vertical direction in this example, the direction may be tilted by a predetermined angle from the vertical direction. Movable portion 11 includes a charging connector 111 and a charging cable 112. Charging connector 111 and charging cable 112 can be accommodated in a storage space provided in an upper portion of movable portion 11.

Charging connector 111 is connected to an inlet 91 (described later herein) of vehicle 9. Charging connector 111 is electrically connected to one end of charging cable 112. To the other end of charging cable 112, a power supply 3 is electrically connected. Power supply 3 is an AC power supply such as commercial power supply, for example. A power converter (not shown) may be provided between charging cable 112 and power supply 3. Charging connector 111 can be removed by a user from the storage space to extend charging cable 112 to inlet 91. Charging connector 111 corresponds to “electric power transmitter” according to the present disclosure.

Elevation unit 12 is secured to the bottom of the recess formed in the ground. Elevation unit 12 lifts and lowers movable portion 11 between the exposed state and the stored state. For elevation unit 12, any of various mechanisms may be employed. Specifically, elevation unit 12 may have a rack and pinion mechanism, a mechanism using a hydraulic cylinder, or have a magnetic mechanism. The rack and pinion mechanism lifts and lowers movable portion 11 by rotating, with an electric actuator, a pinion gear engaged with a rack gear secured to movable portion 11. The mechanism using a hydraulic cylinder secures, to movable portion 11, a rod which is connected to a piston, and increases/decreases the pressure of oil supplied to the cylinder body to thereby lift/lower movable portion 11. The magnetic mechanism generates a magnetic repulsive force between movable portion 11 and elevation unit 12 to thereby lift and lower movable portion 11.

Moreover, elevation unit 12 desirably includes a mechanism (such as stopper) that restricts movement of movable portion 11 to prevent excessive up-and-down movement thereof. Thus, elevation unit 12 is configured to prevent movable portion 11 from being lowered beyond the position corresponding to the stored state, and configured to prevent movable portion 11 from being lifted beyond the position corresponding to the exposed state. Elevation unit 12 corresponds to “elevation device” according to the present disclosure.

As set forth above, charging stand 1 is installed on a walkway. Movable portion 11 is stored underground when not in use, and therefore, it is difficult for pedestrians to notice the presence of movable portion 11. Consequently, lifting/lowering of movable portion 11 could hinder passage of pedestrians. In view of this, according to Embodiment 1, light emitter 13 and/or speaker 14 is used to notify a surrounding pedestrian(s) of lifting/lowering of movable portion 11 when movable portion 11 is lifted/lowered.

Following a control command from controller 15, light emitter 13 emits light when movable portion 11 is lifted/lowered. As light emitter 13, LED (Light Emitting Diode), fluorescent lamp, or organic EL (OEL: Organic Electro-Luminescence) may be employed, for example.

Following a control command from controller 15, speaker 14 outputs sound when movable portion 11 is lifted/lowered.

Controller 15 includes a processor 151 such as CPU (Central Processing Unit), a memory 152 such as ROM (Read Only Memory) and RAM (Random Access Memory), and a communication module 153 capable of wired and/or wireless communication with an external device of charging stand 1. In the present embodiment, communication module 153 is configured to exchange various types of information with a communication module (not shown) of another/other charging stand(s) 1. In this way, a plurality of charging stands 1 can operate in cooperation with each other. Communication module 153 may be configured to communicate with a management server (not shown) that is capable of overall control of a plurality of charging stands 1.

Controller 15 controls constituent devices (elevation unit 12, light emitter 13, and speaker 14) of charging stand 1, based on information stored in memory 152, information received via communication module 153, and/or information acquired from sensors (not shown). Controller 15 performs “lifting control” for lifting movable portion 11 and “lowering control” for lowering movable portion 11. The lifting control is performed, for example, when a user operates mobile terminal 2 to operate an UP button (not shown). The lowering control is performed when a user operates mobile terminal 2 to operate a DOWN button (not shown). Controller 15 corresponds to “control device” according to the present disclosure.

In this example, vehicle 9 is an electric vehicle. Vehicle 9 may at least be a vehicle that can be plug-in charged, and may for example be a plug-in hybrid vehicle. Vehicle 9 includes inlet 91, a charger 92, a battery 93, an inverter 94, and a motor generator 95.

Inlet 91 is placed inside a cover (not shown) such as lid provided in the exterior of vehicle 9. Inlet 91 is configured to allow charging connector 111 of charging stand 1 to be inserted in inlet 91. When charging connector 111 is inserted in inlet 91, inlet 91 and charging connector 111 are electrically connected to each other. Accordingly, electric power can be transmitted from charging stand 1 to vehicle 1.

When AC power is supplied from inlet 91, charger 92 converts the AC power into DC power, and supplies the DC power to battery 93. Battery 93 is a secondary battery such as nickel-metal hydride battery or lithium-ion battery.

Inverter 94 converts DC power stored in battery 93 into AC power, and supplies the AC power to motor generator 95. Inverter 94 also converts AC power (regenerative power) from motor generator 95 into DC power, and charges battery 93 with the DC power. Receiving electric power supplied from inverter 94, motor generator 95 applies rotational force to drive wheels to thereby cause vehicle 9 to run.

<Process Flow>

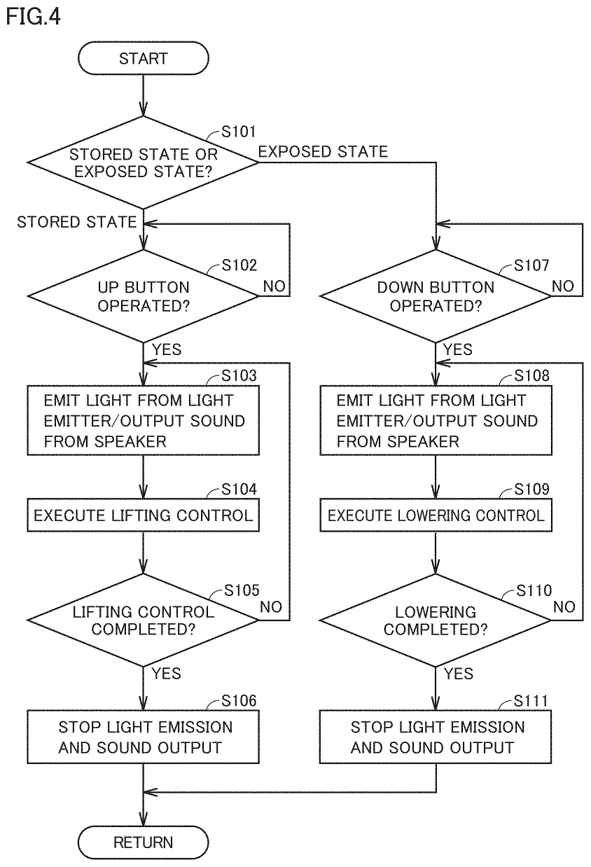

FIG. 4 is a flowchart showing an example process procedure for lifting/lowering control for charging stand 1 according to Embodiment 1. This flowchart is called from a main routine (not shown) and executed at predetermined intervals, for example. While each step is implemented through software processing by controller 15, each step may also be implemented by hardware (electrical circuitry) placed in controller 15. Each step may also be executed by the aforementioned management server (not shown) instead of controller 15. In the following, step is abbreviated as S.

In this example, it is supposed that a user controls mobile terminal 2 to select, in advance, charging stand 1 to be operated. In S101, controller 15 determines whether movable portion 11 of the selected charging stand 1 is in the stored state or the exposed state.

When movable portion 11 is in the stored state (STORED STATE in S101), controller 15 determines whether or not the user has operated the UP button (not shown) for mobile terminal 2 (S102). Controller 15 waits until the UP button is operated (NO in S102). When the UP button is operated (YES in S102), controller 15 controls at least one of light emitter 13 and speaker 14 to notify a surrounding pedestrian(s) of the fact that movable portion 11 is to be lifted (S103). Then, controller 15 performs the lifting control for movable portion (S104). Until the lifting control for movable portion 11 is completed (NO in S105), controller 15 continues causing at least one of light emitter 13 and speaker 14 to give notification. When the lifting control for movable portion 11 is completed (YES in S105), controller 15 ends the notification by at least one of light emitter 13 and speaker 14 (S106).

When movable portion 11 is in the exposed state (EXPOSED STATE in S101), controller 15 determines whether or not a user has operated the DOWN button (not shown) for mobile terminal 2 (S107). Controller 15 waits until the DOWN button is operated (NO in S107). When the DOWN button is operated (YES in S107), controller 15 controls at least one of light emitter 13 and speaker 14 to notify a surrounding pedestrian(s) of the fact that movable portion 11 is to be lowered (S108). Then, controller 15 performs the lowering control for movable portion 11 (S109). Until the lowering control for movable portion 11 is completed (NO in S110), controller 15 continues causing at least one of light emitter 13 and speaker 14 to give notification. When the lowering control for movable portion 11 is completed (YES in S110), controller 15 ends the notification by at least one of light emitter 13 and speaker 14 (S111).

As seen from the above, according to Embodiment 1, light emitter 13 is caused to emit light and/or speaker 14 is caused to output sound prior to and during lifting of movable portion 11, to notify a surrounding pedestrian(s) of the lifting of movable portion 11. The surrounding pedestrian(s) thus recognizes that movable portion 11 is to be lifted or is being lifted. Accordingly, the risk of hindering passage of a pedestrian(s) due to lifting/lowering of movable portion 11 can be reduced.

In connection with the present embodiment, the feature that both light emitter 13 and speaker 14 are provided in charging stand 1 is described above by way of example. Alternatively, however, only one of light emitter 13 and speaker 14 may be provided in charging stand 1. Moreover, light emitter 13 and speaker 14 may give a notification of only one of lifting and lowering of movable portion 11.

### Modification of Embodiment 1

FIG. 5 is a flowchart showing an example process relating to condition setting for lifting/lowering control for charging stand 1 according to a modification of Embodiment 1. In S201, controller 15 determines whether or not the current time is nighttime. When the current time is nighttime (YES in S201), controller 15 sets the light emission amount of light emitter 13 to a smaller amount than a normal amount (S202), and sets the sound volume of speaker 14 to a smaller volume than a normal volume (S203). When the current time is not nighttime (NO in S201, i.e., daytime, for example), controller 15 sets the light emission amount of light emitter 13 to the normal amount (S204) and sets the sound volume of speaker 14 to the normal volume (S205).

Thus, this modification takes account of the period of time in the day to reduce the light emission amount of light emitter 13 and the sound volume of speaker 14 during the nighttime. Accordingly, annoyance that could be caused to neighborhood residents (and surrounding pedestrians) due to lifting/lowering of movable portion 11 can be suppressed.

### Embodiment 2

In connection with following Embodiments 2 and 3, execution of the lifting/lowering control for a plurality of charging stands 1 in the same period of time is described. Control details for each charging stand 1 are similar to those shown in the flowchart of FIG. 4, and therefore, the description thereof is not herein repeated.

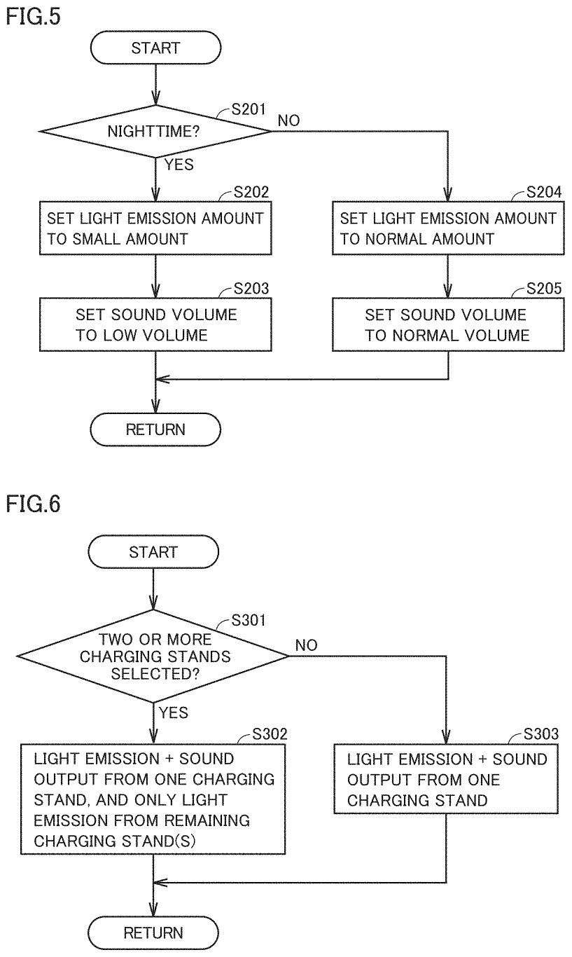

FIG. 6 is a flowchart showing an example process relating to condition setting for lifting/lowering control for charging stand 1 according to Embodiment 2. In S301, controller 15 of a certain charging stand communicates with another/other charging stands to determine whether or not two or more charging stands have been selected, i.e., determine whether or not any charging stand other than the certain charging stand has been selected.

When two or more charging stands have been selected (YES in S301), controller 15 communicates with the other charging stand(s) to specify control conditions for light emitter 13 and speaker 14. Specifically, controller 15 specifies control conditions such that light emitter 13 emits light and speaker 14 outputs sound in any one charging stand among the selected multiple charging stands, while light emitter 13 emits light but speaker 14 outputs no sound in the remaining charging stand(s) among the selected multiple charging stands.

The way to select the charging stand in which both light emission from light emitter 13 and sound output from speaker 14 are carried out is not particularly limited. For example, in a charging stand that was selected earliest, light emitter 13 may emit light and speaker 14 may also output sound. In a charging stand that started being lifted/lowered earliest, light emitter 13 may emit light and speaker 14 may also output sound. Alternatively, priorities may be assigned in advance to respective charging stands, based on the location where each charging stand is placed, for example.

When two or more charging stands have not been selected (NO in S301), i.e., when only one charging stand has been selected, controller 15 follows the normal procedure to cause light emitter 13 of the charging stand to emit light and speaker 14 thereof to output sound (S303).

It would be possible to simply cause respective speakers 14 of all the selected charging stands to output sound. However, in such a case, the output sound could cause annoyance to neighborhood residents and surrounding pedestrians. According to Embodiment 2, the number of speakers from which sound is output is restricted, and therefore, the aforementioned annoyance can be reduced.

In connection with this example, the feature is described above that it is only one charging stand in which both light emission from light emitter 13 and sound output from speaker 14 are carried out. The number of charging stands in which both light emission and sound output are carried out, however, may be two or more, as long as the number is not the number of all the selected multiple charging stands. In other words, it may at least be a part of the selected multiple charging stands that is/are caused to emit light and also output sound.

### Embodiment 3

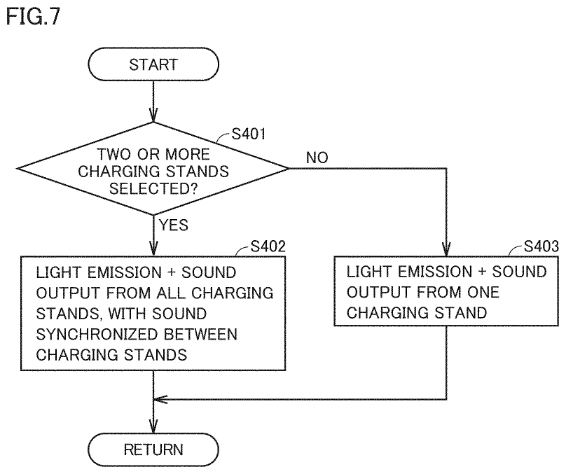

FIG. 7 is a flowchart showing an example process relating to condition setting for lifting/lowering control for charging stand 1 according to Embodiment 3. In S401, controller 15 of a certain charging stand communicates with another/other charging stands to determine whether or not two or more charging stands have been selected.

When two or more charging stands have been selected (YES in S401), controller 15 communicates with the other charging stand(s) to specify control conditions for light emitter 13 and speaker 14 such that light emitter 13 emits light and speaker 14 outputs sound in all the charging stands. In addition, controller 15 specifies control conditions for speaker 14 such that respective sounds that are output from speakers 14 of all the charging stands are synchronized with each other (S402).

When only one charging stand has been selected (NO in S401), controller 15 follows the normal procedure to cause light emitter 13 of the charging stand to emit light and speaker 14 thereof to output sound (S403).

In accordance with Embodiment 3, respective sounds that are output from a plurality of speakers 14 are synchronized with each other, and therefore, annoyance that could be caused by sound can be reduced as in Embodiment 2.

It is also possible to combine Embodiment 2, 3 with the modification of Embodiment 1. Specifically, in each of Embodiments 2 and 3, the amount of light emission from light emitter 13 and the volume of sound from speaker 14 can be reduced as well during the nighttime relative to the daytime.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging system for a vehicle, the charging system comprising at least one charging stand,
the at least one charging stand comprising:
a movable portion including an electric power transmitter that transmits electric power to the vehicle;
an elevation device that lifts and lowers the movable portion between an exposed state in which the movable portion is exposed from ground and a stored state in which the movable portion is stored underground;
a notification device including at least one of a light emitter that emits light during lifting and lowering of the movable portion and a speaker that outputs sound during lifting and lowering of the movable portion, the notification device notifying a surrounding of at least one of lifting and lowering of the movable portion; and
a control device that controls the elevation device and the notification device.

2. The charging system for a vehicle according to claim 1, wherein
the notification device includes the light emitter, and
the control device reduces an amount of light emission from the light emitter during a predetermined period of time in nighttime, relative to an amount of light emission from the light emitter during a period of time other than the predetermined period of time.

3. The charging system for a vehicle according to claim 1, wherein
the notification device includes the speaker, and
the control device reduces a volume of sound from the speaker during a predetermined period of time in nighttime, relative to a volume of sound from the speaker during a period of time other than the predetermined period of time.

4. The charging system for a vehicle according to claim 1, wherein
the at least one charging stand is a plurality of charging stands,
the notification device of each of the plurality of charging stands includes the light emitter and the speaker, and
when the movable portion of each of two or more charging stands among the plurality of charging stands is lifted and lowered, the control device
causes the speaker to output sound that is included in a part of the two or more charging stands, and
causes the light emitter to emit light and the speaker to output no sound that are included in remaining at least one charging stand among the two or more charging stands.

5. The charging system for a vehicle according to claim 1, wherein
the at least one charging stand is a plurality of charging stands,
the notification device of each of the plurality of charging stands includes the speaker, and
when the movable portion of each of two or more charging stands among the plurality of charging stands is lifted and lowered, the control device causes respective sounds that are output from the speakers of the two or more charging stands to be synchronized with each other.

6. A method of controlling a charging system for a vehicle, the method comprising:
lifting and lowering a movable portion between a state in which the movable portion is exposed from ground and a state in which the movable portion is stored underground, the movable portion including an electric power transmitter that transmits electric power to the vehicle; and
notifying a surrounding of at least one of lifting and lowering of the movable portion by means of light or sound.
